(19) United States
(12) Patent Application Publication
(10) Pub. No.: US 2006/0122858 A1
(43) Pub. Date: Jun. 8, 2006

(54) Item management systems and associated methods

(75) Inventors: Michael D. Miles, Portland, OR (US); Ron Wiener, Portland, OR (US); Brett R. Prochaska, Portland, OR (US)

Correspondence Address: PERKINS COIE LLP;PATENT-SEA, P.O. BOX 1247, SEATTLE, WA, 98111-1247, US

(73) Assignee: Document Command, Inc.

(21) Appl. No.: 11/253,091

(22) Filed: Oct. 17, 2005

Related U.S. Application Data
(63) Continuation-in-part of application No. 11/195,491, filed on Aug. 1, 2005.
(60) Provisional application No. 60/619,367, filed on Oct. 15, 2004.
(60) Provisional application No. 60/626,571, filed on Nov. 9, 2004.

(51) Int. Cl. G06Q 99/00

(52) U.S. Cl. 705/1

(57) ABSTRACT

The present invention is directed generally toward item management systems and associated methods. Aspects of the invention are directed toward receiving items, inducting the items into the item management system and storing the items. In certain embodiments, inducting the item can include imaging at least a portion of the item and providing that image to a remote user. Other aspects of the invention include retrieving the items form storage and processing the items. In selected embodiments, processing an item can include processing the item in accordance with instructions provided by a remote user. In certain embodiments, at least some of the items that have been processed can then be returned to storage. Still other aspects of the invention can include monitoring various portions of the item management process. In selected embodiments, various aspects of the invention can be automated and/or computer controlled. Additionally, various aspects of the invention can allow non-uniform items to be stored in a uniform structure.

### CROSS-REFERENCE TO RELATED APPLICATIONS

This non-provisional application is a continuation-in-part of U.S. patent application Ser. No. 11/195,491, which is fully incorporated herein in its entirety by reference. Additionally, this non-provisional application claims the benefit of and priority to provisional U.S. Patent Application No. 60/592,648, filed Jul. 30, 2004, provisional U.S. Patent Application No. 60/619,367, filed Oct. 15, 2004, and provisional U.S. Patent Application No. 60/626,571, filed Nov. 9, 2004, all of which are incorporated herein in their entirety by reference thereto.

### TECHNICAL FIELD

Embodiments of the present invention relate to item management systems and associated methods, including automated remote control document management systems.

### BACKGROUND

Sending, transporting, receiving, reviewing, copying, storing, retrieving, and destroying paper documents is time consuming and costly for individuals and businesses. Additionally, the destruction and disposal of paper documents can negatively impact the environment unless these paper documents are recycled, which in itself can be time consuming and expensive. Regulatory requirements (Sarbanes-Oxley, HIPPM, etc.) continue to add to the complexity and cost of managing paper documents. The “paperless office” concept has been with us since the mid-1970's, but has for various reasons not fully come to fruition. Accordingly, there is still a need to physically store paper documents, as well as other items, in a manner such that the documents can be tracked, retrieved, reviewed, replaced in storage, and/or destroyed.

Another problem with paper documents is that they typically require a person reviewing the documents to be physically located with the documents. For example, if someone has more than one residence, has more than one office, and/or spends a significant amount of time traveling, it can be difficult to keep track of the mail or other documents that get delivered to various locations. This problem is often solved by tasking someone at each of the various locations to pickup, review, and/or forward the mail or other documents delivered to the associated location. This solution can be inefficient and costly, and in some cases can delay the receipt of time sensitive information.

### BRIEF DESCRIPTION OF THE DRAWINGS

FIG. 1 is a schematic flow chart showing an item management process in accordance with an embodiment of the present invention.

FIG. 2 is a partially schematic illustration of an item with an identification tag in accordance with certain embodiments of the invention.

FIG. 3 is a partially schematic illustration of an item management system in accordance with embodiments of the present invention.

FIG. 4 is a schematic block diagram that illustrates a computing environment suitable for implementing or aiding various portions of item management processes in accordance with embodiments of the invention.

FIG. 5 illustrates a computer display through which a user can interface/interact with an item management process that includes a remote document process in accordance with embodiments of the present invention.

FIG. 6 illustrates another computer display through which a user can interface/interact with an item management process that includes a remote document process in accordance with other embodiments of the invention.

FIG. 7 is a schematic flow chart showing a one-touch induction process in accordance with certain embodiments of the invention.

FIG. 8 is a schematic flow chart showing a two-touch induction process in accordance with other embodiments of the invention.

FIG. 9 is a partially schematic illustration of a storage center of the item management system in accordance with certain embodiments of the invention.

FIG. 10 is an isometric illustration of an individual storage rack of a storage center configured to store multiple different types of containers that contain one or more documents in accordance with various embodiments of the invention.

FIGS. 11-13 are isometric illustrations of a rack with a robotic manipulator and portions of the rack used to insert containers that contain one or more documents into the rack, remove the containers from the rack, and manipulate the containers relative to the rack in accordance with other embodiments of the invention.

FIG. 14 is an isometric illustration of a portion of a storage center with containers attached to one or more conveyor systems in accordance with certain embodiments of the invention.

FIG. 15 is an isometric illustration of a chute system used to transfer items in the storage center shown in FIG. 14 in accordance with certain embodiments of the invention.

FIG. 16 is an isometric illustration of a portion of a storage center with a chute system for transferring containers between one portion of the storage center and another in accordance with certain embodiments of the invention.

FIG. 17 is a schematic flow chart showing a scanning process performed at a processing center in an item management system in accordance with embodiments of the invention.

FIG. 18 is an isometric illustration of a manual induction station in accordance with certain embodiments of the invention.

### DETAILED DESCRIPTION

The present disclosure describes item management systems and associated methods in accordance with certain embodiments of the present invention. Several specific details of the invention are set forth in the following description and the Figures to provide a thorough understanding of certain embodiments of the invention. One skilled in the art, however, will understand that the present invention may have additional embodiments, and that other embodiments of the invention may be practiced without several of the specific features described below.

Introduction

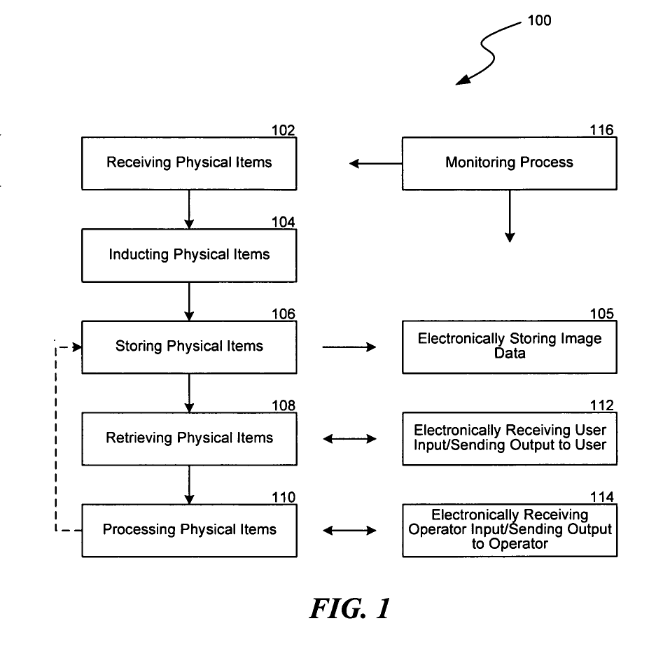

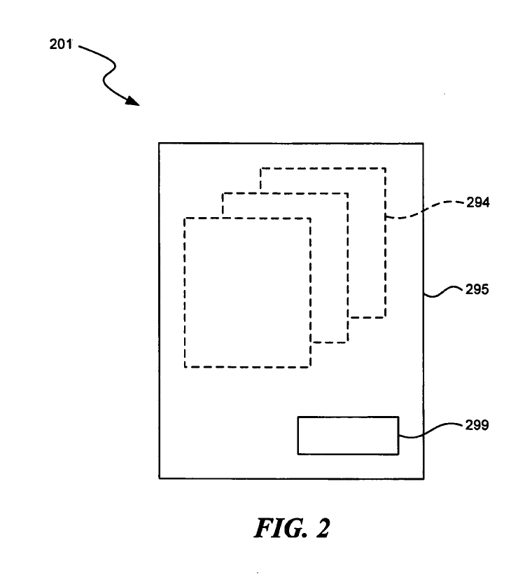

The present invention is directed generally toward item management systems and associated methods. As shown in FIG. 1, selected aspects of the invention are directed toward an item management process 100 that includes receiving physical items (process portion 102), inducting the items, including imaging the items into the item management system (process portion 104), electronically storing image data related to each item (process portion 105), and storing the physical items in a selected and identified location (process portion 106). The items can include any physical item including a single piece of paper, an envelope, a piece of mail, a magazine, a group of documents (e.g., a letter with multiple pages), CD or DVD, a group of CD/DVDs, a package, a book and/or other physical items. In selected embodiments, the items have non-uniform shapes and sizes relative to each other. In certain embodiments, inducting the item can include gathering information about the item, assigning or applying a unique identifier (e.g., a code, tag, a marking, or other identification), scanning or imaging at least a portion of the item, and/or preparing the item for storage. Applying the identifier can include any identification arrangement including physically configuring the item for identification or attaching a material to the item. For example, as shown in certain embodiments a piece of paper can have symbols or a code printed onto the paper or physically pressed or crimped into the paper itself so that the paper can later be identified. In other embodiments a radio frequency identification tag, a bar code, one or two dimensional symbology, and/or other unique identifier can be coupled to the item. FIG. 2 is a partially schematic illustration of an item 201 with an identifier 299 in accordance with certain embodiments of the invention. In FIG. 2, the item 201 includes packaging 295 (e.g., an envelope or pouch) and content 294 (e.g., documents inside of the packaging). In other embodiments, the item 201 can have other arrangements and/or the identifier can be applied to other portions of the item 201.

Referring back to FIG. 1, other aspects of the invention can include retrieving the inducted items from storage (process portion 108) and processing the items (process portion 110) in accordance with instructions for each of the items. In certain embodiments processing the item (process portion 110) after retrieval or induction can include sending the physical item to a recipient or user (e.g., an entity including a person and/or organization remote from the storage center), forwarding the physical item to another remote entity or location, scanning one or more portions of the item to provide a visual image of the item's portion to a remote recipient, archiving the item, shredding the item, disposing of the item, and/or recycling the item. In selected embodiments, at least some of the items that have been processed can be returned to storage (process portion 106).

In certain embodiments, the item management process can also include receiving user input from a remote location and/or sending output to the remote user (process portion 112). Additionally, in selected embodiments the item management process can include receiving operator input and/or sending output to the operator (process portion 114). In various embodiments, the operator can be on-site at the item management center or at a remote location.

For example, in selected embodiments if the item is a piece of mail, all or a portion of the envelope is scanned during induction, and that image of the envelope can be electronically sent to a remote user, such as via a computer network. The remote user can then provide instructions on how the piece of mail should be processed. Additionally, in certain embodiments a remote user can set up rules for how certain items should be handled or processed in the item management process. Similarly, in certain embodiments the operator (e.g., an entity) can receive information regarding selected items (e.g., items that are difficult to identify during the induction process) and provide input on how to handle the selected item in the item management process. In still other embodiments, the item management process can also include one or more monitoring processes that can be used to monitor substantially all or various portions of the item management process (process portion 116). In yet other embodiments, various aspects of the invention can be automated and/or computer controlled.

The item management process 100 can be used to accomplish various tasks. For example, various aspects of the invention allow a non-uniform item to be stored in a uniform structure. For instance, in certain embodiments, items having non-homogeneous physical characteristics or dimensions (e.g., outer shapes and sizes) to be stored in carriers or rack locations having substantially homogeneous dimensions (e.g., outer shapes and sizes). In selected embodiments, the uniform structures (e.g., carriers) containing the items can be manipulated manually or automatically during selected process steps. Other aspects can allow the storage and/or retrieval of specifically identified and discrete items in a specific sequence. Still other aspects of the invention can allow the physical items to be received at one location, remotely reviewed, and/or processed in accordance with instructions provided by a remote user or an operator. Various embodiments of the item management process 100 can be used to form various systems including document control or storage systems and/or other item control systems (e.g., CD/DVD data storage systems, CD/DVD rental services, book lending services and/or other goods-related systems and services).

In selected embodiments, the item management process 100 can also be used in a remote mail service in accordance with instructions from the remote user. For example, in certain embodiments a remote mail service can allow a user to have mail (e.g., U.S. Postal mail and/or internal company mail) delivered to a specified location remote from the user's location, the mail can go through the receiving and induction process, and the remote user can then review an image of at least a portion of each mail item (e.g., the envelope or package), such as over the internet or other computer network. The remote user can provide instructions via the computer network on how the mail should be processed at the mail processing location. For example, the user can have the entire mail item (e.g., an envelope and its contents) scanned or otherwise imaged, and the image sent to the remote user via the computer network for review. The user can provide instructions to have the mail item sent to another remote entity or location, recycled, destroyed, shredded, or archived. In selected embodiments, the remote user can set up rules or instructions in advance via a user interface available over the network so that certain mail items are automatically processed in accordance with the instructions when they are received and inducted into the system at the mail processing location.

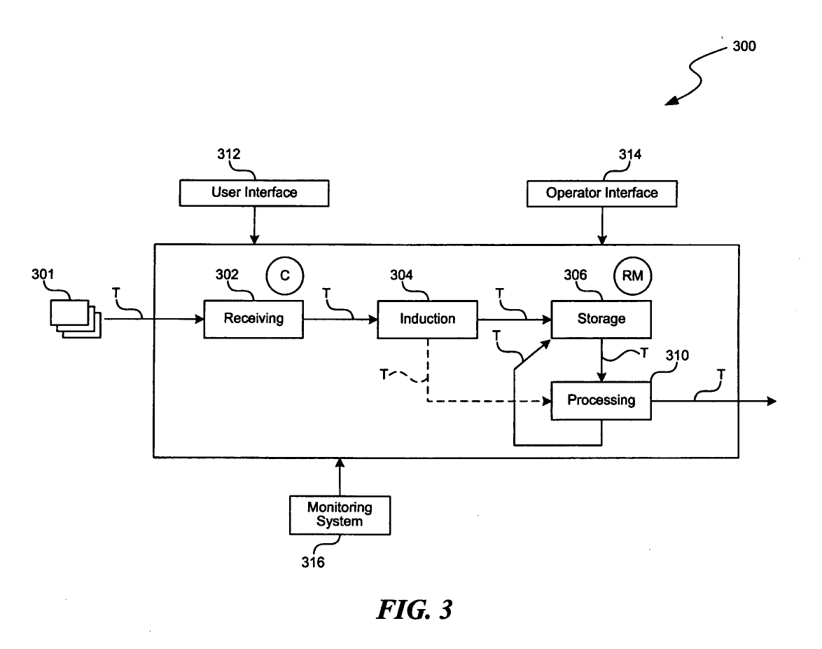

FIG. 3 is a partially schematic illustration of an item management system 300 in accordance with various embodiments of the invention. The item management system 300 located remote from the user can receive physical items 301 at a receiving station 302. The receiving station 302 can have a cache C for holding items 301 until each of the items can complete the receiving process and/or the item can be moved to an induction center 306. The induction center 306 can perform the induction process described above. Additionally, after at least a portion of the item is imaged during the induction process, the image of the item and/or at least a portion of the information gathered about the item can be sent to a remote user via the computer network and presented to the remote user via the user interface 312. The remote user can also provide input, such as instructions, to the item management system 300 via the user interface 312, for example, to provide instruction for processing each item. Similarly, the item management system 300 includes an operator interface 314 through which an on-site or remote operator can receive output (e.g., information) from the item management system 300 and through which the operator can provide input (instructions) to the item management system 300 for processing the item or performing other related tasks. In selected embodiments, the operator can receive output and provide input via a network and the operator interface.

In certain embodiments, the induction process includes receiving the item, identifying one or more markings (e.g., an address, symbology, a code, or other information on the item), and analyzing the markings to determine which remote user(s) is/are associated with the particular item. For example, in a document management system there may be multiple remote users or entities associated with a single item. In one embodiment, an Optical Character Recognition (OCR) process is used to “read” the marking on the item so the item can be associated with the proper remote user(s). Other embodiments can use other systems, such as bar code systems, symbol-reading systems, radio frequency identification systems, or other identification systems to accurately determine which remote user(s) is/are associated with the item. Accordingly, each item can be processed in accordance with the instructions from the correct remote user(s), as discussed in greater detail below.

After the induction process is completed and the item is associated with the correct remote user(s), the physical item can be transferred to a storage center 306. In one embodiment, the location of each item in the storage center and to/from the storage center is tracked via the identifier on each item. The storage center 306 can store the item so that the item can be quickly and accurately identified, stored, moved, and/or retrieved because the location of each item is always known by using the identifier to track the exact location of the item (e.g., via a computing system) in the storage center. For example, the identifier may be a bar code, and each time the item is moved, the bar code is scanned and its location is correlated with other bar codes associated with each location in the storage center. Additionally, in certain embodiments where the items have different physical parameters (e.g., shapes, sizes, and weight) the storage center can be configured to store each non-uniform item in a uniform structure. In certain embodiments, the item and the uniform structure are then moved together as a unit within the storage center. For example, in certain embodiments of a remote mail center where different mail items have different sizes and shapes, each mail item can be placed in a cassette or other type of storage container. The outer portions of the cassettes are uniform in shape and size so that they can be manipulated and stored in any one of multiple positions in a rack system or other storage structure, as discussed in greater detail below.

Additionally, in selected embodiments the cassettes and/or the rack system can have unique identifying features to aid in tracking and retrieving a particular cassette and its item at a later time for further processing. For example, in certain embodiments the cassette and storage areas in the rack system each have unique identifiers. The identifier on an item can be matched or otherwise associated with an identifier on a cassette, and the identifier on the cassette is matched or otherwise associated with the identifier of the storage area in the rack system. When a cassette and item are moved, the cassette identifier is re-associated with the identifier at the new location. Accordingly, the location of each item in the system is always tracked, known, and the item can be quickly retrieved from the storage center 306 for processing at any time. Additionally, in selected embodiments the storage process can include re-arranging or organizing items in the rack system after they have been stored to expedite the retrieval process. For example, in a remote mail system, various mail items in their respective cassettes (when used) can be re-arranged or organized in a rack system (e.g., moved from one location in the rack system to another) so that the item, which are likely to retrieved at the same time are physically proximate to each other. In certain embodiments, various transport mechanisms (e.g., conveyor systems) and/or one or more robotic manipulators RM can be used to move the items throughout the storage center, for example, during initial storage, re-storage (e.g., an item returned after processing), organization, and/or retrieval.

Once an item is retrieved from the storage center 306 it can move to a processing center 310. At the processing center 310, the item can undergo various types of processing, including scanning or imaging (e.g., scanning the entire content of the item for transmission to the remote user or other entity via the computer network), preparing the item for physical shipment to the remote user or other entity, destroying the item, recycling the item, and/or archiving the item. After the processing steps are completed, the remaining items can be returned to the storage center. For example, in certain embodiments an item being archived or scanned during processing might be returned to the storage center 306 after the processing is complete. In selected other embodiments, archived items can be stored in a designated portion of the storage center 306, because those archived items are not expected to be accessed in the near term.

In other embodiments, processing can simply include the item moving through the processing station. For example, in certain embodiments multiple items are removed from the rack system in a group and as the group of items move through the processing center 310, while other items are scanned, archived, sent out of the system, and/or destroyed, some of the items are simply returned to storage in a selected location in the rack system. As indicated above, the specific location of each item is tracked via its identifier as the item moves within the processing center 310 or the storage center 306. In certain embodiments, items move to the processing center 310 after induction without passing through the storage center 306. For example, as discussed above, in a remote mail system the remote user or the operator can set up rules in advance such that certain items identified during the induction process are sent directly to processing and recycled, queued for disposal, sent to the remote user, or another entity.

The items 301 can be moved throughout the item management system 300 (e.g., between the various stations) via transport mechanisms T and/or manual labor. The transport mechanisms T can have various transport elements including conveyors, carts, robotic manipulators, carriers or pallets, cassettes and/or storage units. In various embodiments, the transport mechanisms T can be manually operated, partially automated, or fully automated. In certain embodiments, all or a portion of the transport mechanisms T can be computer controlled. Any of the various stations in the item management system 300 can also include one or more transport mechanisms T as needed for each station, for example, one or more robotic manipulators that interact with carriers on an adjacent conveyor system. Additionally, any of the various stations in the item management system 300 and/or portions of the transport mechanism T can also include a cache C, similar to that discussed above with reference to the receiving station 302 to temporarily hold the items until they can be further processed. The caches C can also include unique identifiers that can be associated with the identifier of each item to accurately track the location of each item. It is understood, that in certain embodiments various elements of each of the various centers in the item management system can physically overlap.

In certain embodiments, the item management system 300 can also include a monitoring arrangement or monitoring system 316 to monitor various portions of the item management system 300 or item management process. For example, the monitoring system 316 can provide tracking, observation, and location information of the items while they are in the item monitoring system 300. The monitoring system 316 can be completely manually operated, partially automated, or fully automated. In certain embodiments, at least a portion of the monitoring system 316 can be computer implemented and/or computer aided. In selected embodiments, the monitoring system 316 can include a video camera or video system to visually record the items in various portions of the item management system 300 or item management process. In other embodiments, the system can include other electronic monitoring devices, for example, still cameras, Radio Frequency Identification (RFID) receivers/readers, and barcode reading devices. Additionally, in some embodiments monitoring can be accomplished remotely. For example, when using a video system to monitor a portion of the item management process, the visual images can be sent via a network to a remote location where the images can be stored and/or reviewed.

The information collected by the monitoring system 316 can be useful for many purposes. For example, in certain embodiments the monitoring system 316 can provide information in the event an item does not arrive at its intended location or if the item is a sealed pouch containing confidential information the monitoring system can provide an indication that the contents may have been accessed by unauthorized observers. In selected embodiments, a portion of the information collected by the monitoring system 316 can be provided to the owner, recipient, or other authorized entity associated with a specific item to provide a record of the events that transpired during the handling of the specific item. In other embodiments, information collected by the monitoring system 316 can be examined by an operator and the operator can provide input to the system via the operator interface 314 based on the information. For example, in certain situations, an operator can provide input to correct a problem that is observed via the monitoring system 316. The monitoring system 316 can also act as a security system that monitors the on-site operations and/or operators as items are moved through and between various centers.

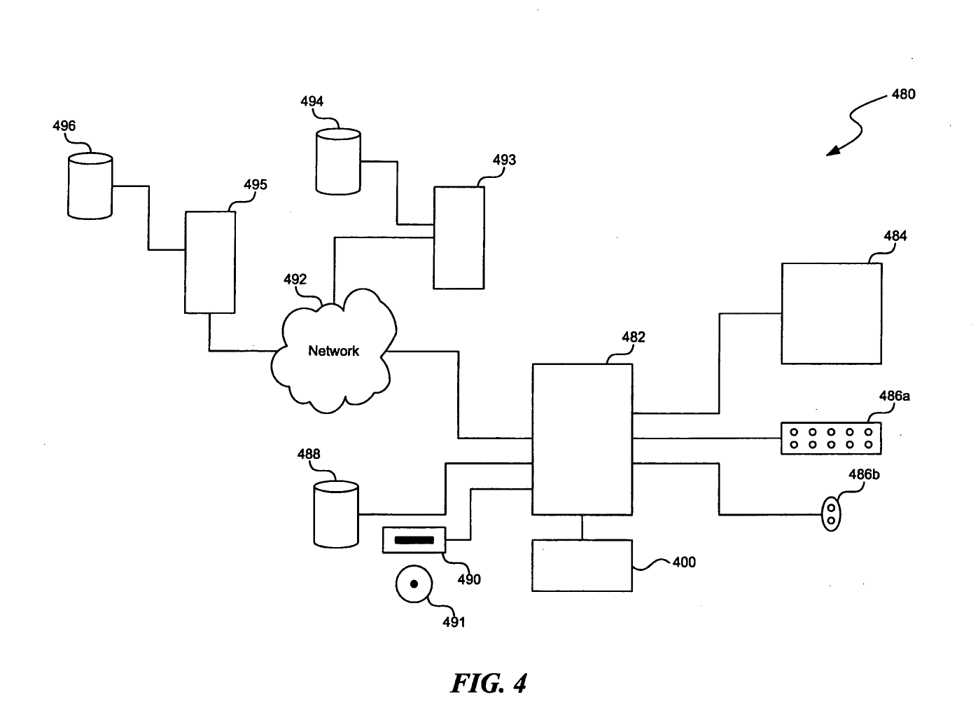

As discussed above, portions of the item management system can be computer implemented, controlled, or aided. Additionally, various computing systems can be used to interface with one or more portions of the item management system. FIG. 4 is a block diagram that illustrates a computing environment suitable for implementing or aiding various portions of item management processes in accordance with embodiments of the invention. The computing environment 480 can be operably coupled to, or integral with, at least a portion of an item management system 400, similar to the item management system described above with reference to FIG. 3. The computing environment 480 can include a computing or computer system 482 that can be operably connected or coupled to a display 484 and one or more input devices, for example, a keyboard 486a and a pointing device 486b (e.g., a mouse). Additionally, the computer system 482 can communicate with one or more storage devices (e.g., a hard drive 488 with one or more databases) and one or more devices 490 for reading other types of computer readable mediums (e.g., devices for reading disks 491).

The computer system 482 can also communicate via a network 492 (e.g., the Internet) with other devices or systems. For example, in the illustrated embodiment the computer system 482 can communicate with a user computer system 493, a user database 494, an operator computer system 495, and/or an operator database 496 via the network 492. In other embodiments, the computing environment 480 can have other arrangements, including more, fewer, and/or different components.

For example, the computing device or environment on which the system is implemented may include a central processing unit, memory, additional input devices (e.g., keyboard, pointing devices, and/or other sensors), other output devices (e.g., display devices), and other storage devices (e.g., disk drives). The memory and storage devices can include computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Portions of the item management system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems can include cell phones, personal digital assistants, smart phones, personal computers, programmable consumer electronics, digital cameras, and so on.

Furthermore, various portions of the system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

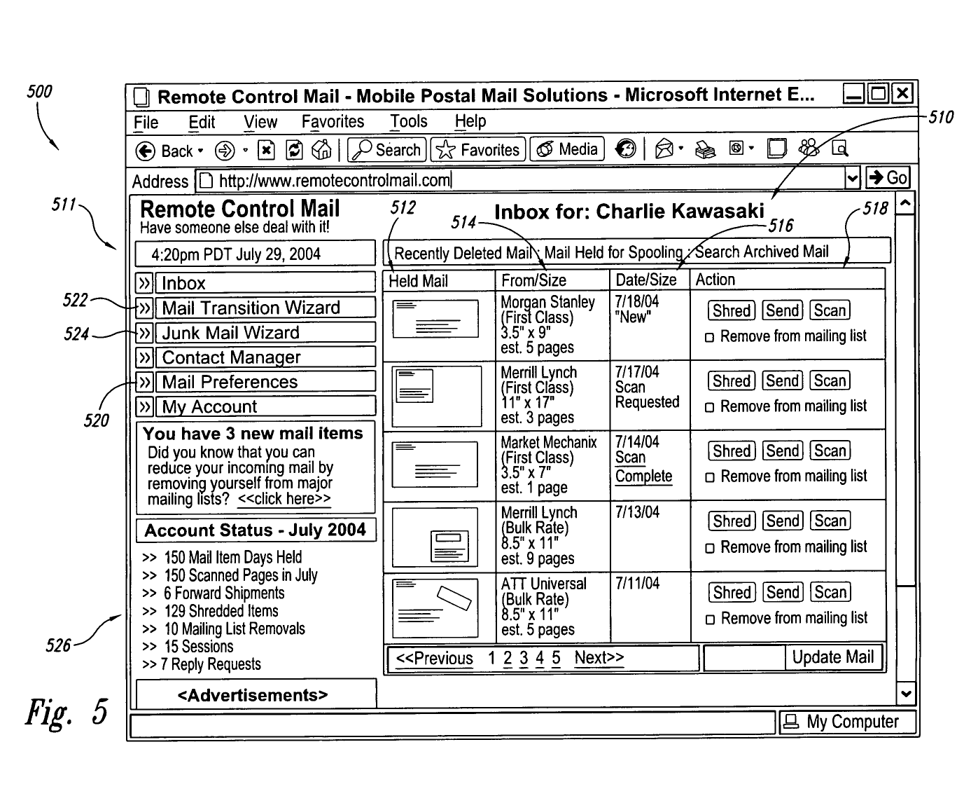

FIG. 5 illustrates a computer display 500 through which a user can interface/interact with an item management process that includes a remote mail process in accordance with embodiments of the present invention. In FIG. 5, the user interface display 500 is accessed through a network (e.g., the internet). The display can include an inbox 510, multiple links 511 to various other displays associated with the mail process, and other information 526.

In the illustrated embodiment, the inbox includes an image section 512, a physical data section 514, a status section 516, and an action section 518. The image section 512 can include images of portions of the items that have been inducted into the item management process at the remote facility. The physical data section 514 can include physical data about the item, including size, weight, the type of mail (e.g., first class or bulk postage), the name of the entity sending the mail, the estimated number of pages (e.g., based on size and weight), and/or other information. The status section 514 can include the date the item was received and whether the item has undergone any processing.

In FIG. 5, the action section 518 can include a menu or entry field where the remote user can provide instructions regarding the processing of the individual items. For example, in the illustrated embodiment the user can choose to shred a mail item, scan a mail item, or send a mail item. For example, if the user chooses to shred the mail item, the item will be shredded and recycled. In some embodiments, the item management process can include selling the recycled material. If the user chooses to scan a mail item, an additional screen can allow the user to choose to scan the entire item or a certain number of pages. Once the item is scanned the user can view the scanned images and if necessary provide additional instructions. If the user chooses to send a mail item, an additional screen can allow the user to send the item to the user or another entity. In FIG. 5, the user can also select the “remove from mailing list” option. This option can provide feedback to the item management process that indicates the user wishes to be removed from the mailing list of the entity that mailed the selected piece of mail. The management process can track this information and provide this information to various bulk mailing entities and/or to the specific entity that mailed the selected item.

The multiple links portion 511 of the display can include links to various pages including a mail transition wizard 522, a junk mail wizard 524, a mail preferences section 520, and/or other information (e.g., account information and a contact link for contacting the managers of the item management system). The mail preferences section 520 can be used, for among other things, setting up rules regarding various mail items that are inducted into the item management system and/or to allow the user to customize display formats for the user's inbox. For example, the mail preference section 520 can allow the user to indicate that mail meeting certain criteria (e.g., from certain sources and/or certain classes of mail) be deleted, shredded, recycled, held, and/or completely scanned immediately upon receipt. The transition wizard 522 can allow mail meeting certain criteria to be sent to the user or another entity immediately after induction. The junk mail wizard 524 can allow a user to designate mail meeting certain criteria to be automatically deleted, shredded, destroyed, or recycled upon receipt and in some cases direct the item management process to send a notice to the direct mail marketing entity that the user does not wish to receive any more direct marketing offers. The computer display 500 can also include other information 526 such as advertising, notices, and summary information.

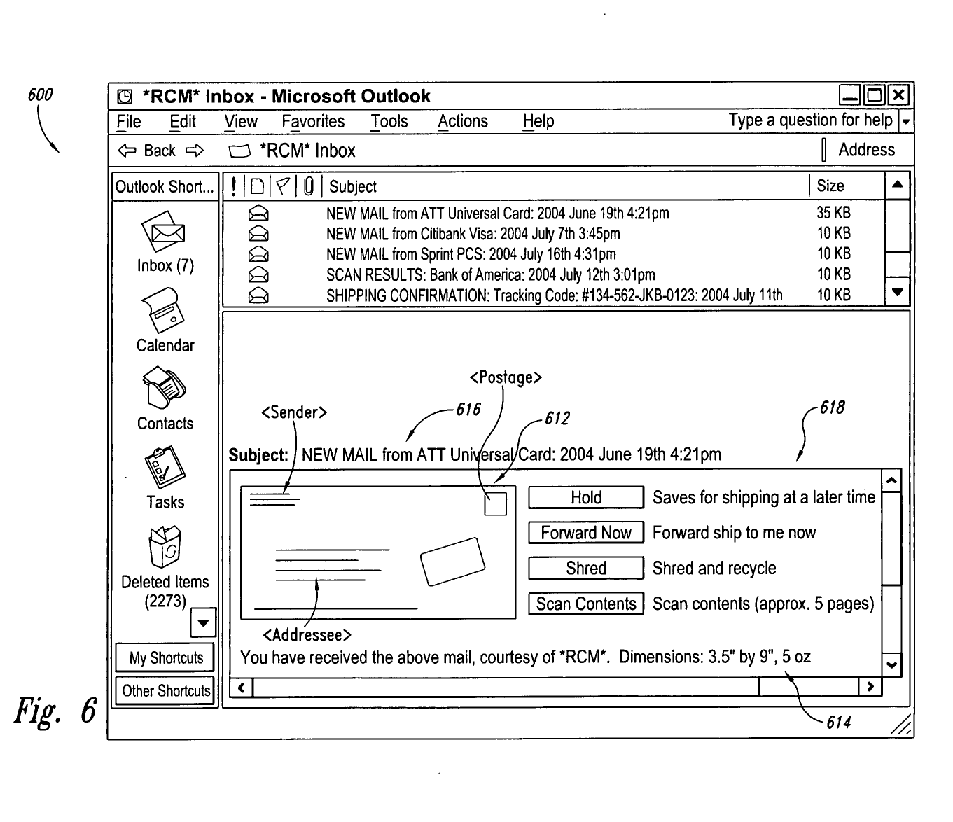

Other display pages can include other arrangements, can be arranged to perform other functions, and/or can be adapted for other types of item management systems. For example, FIG. 6 illustrates another computer display 600 through which a user can interface/interact with an item management process via personal management software, for example, through Microsoft® Outlook®, which is available from the Microsoft Corporation of Redmond, Wash. The computer display 600 in FIG. 6 includes an image section 612, a physical data section 614, a status section 616, and an action section 618.

In the illustrated embodiment, the action section 618 includes a hold function, a forward now function, a shred function, and a scan contents function. The hold function allows items to be held and shipped later. For example, it can allow the user to have an item held for a month and then shipped to a selected address (e.g., after the user returns from an extended trip). The forward now function allows the user to forward the mail item to the user immediately and the scan function allows the user to have the entire item scanned so that the entire item can be electronically reviewed. The shred function allows the user to shred and recycle the mail item. In other embodiments, the user can have the option to recycle an item without shredding. In selected embodiments, the item management process can include holding an item selected for deletion, destruction, shredding, and/or recycling for a period of time so that the user can cancel the deletion, destruction, shredding, and/or recycling of the item for a period of time (e.g., 1-3 days).

In certain embodiments, the operator interface can include display pages similar to those described above with reference to the remote user display pages so that an operator can receive information from the item management process, monitor portions of the item management process, and/or provide input to the item management process. For example, if a remote user does not have network access, the user can contact an operator via phone and provide instructions regarding the disposition of mail for a period of time. The operator can then interface with the item management system using “operator display pages” to carry out the user's instructions. Additionally, the “operator display pages” can allow the user to provide instructions to the item management process for other reasons. For example, the operator can provide instructions to the item management system to correct errors and/or to override automatic rules set up by the user. For example, if there is a natural disaster that affects the area where a user has items automatically sent, the operator can suspend the automatic sending of items to that address and notify the remote user that the automatic deliveries have been suspended. The remote user can then provide new instructions regarding the affected items.

Various embodiments of portions of the item management processes and item management systems, discussed above are discussed below in further detail. One skilled in the art, however, will understand that the present invention is not limited by these embodiments, that the present invention may have additional embodiments, and that other embodiments of the invention may be practiced without several of the specific features described below. Additionally, although for the purpose of illustration many of the embodiments below are described in the context of a remote mail system, it is understood that many or all of these embodiments are applicable to other types of items and/or item management systems.

Receiving an Item

Items can be received by the item management system via various methods. The process of receiving the item includes attaining physically possession of the item, and in some cases inspecting the item for damage and/or moving the item to a location where the induction process starts or begins. For example, in the case of a remote mail system, a user can have mail delivered to a physical building address, post office box, or a private mail box (PMB) by a commercial mail receiving agency. The mail can be picked up from the delivery location and transported to a facility remote from the user where the induction process will take place. The mail can be inspected for damage and positioned to begin the induction process. In other embodiments, the facility that includes the item management system can be a commercial mail receiving agency and have PMBs assigned to various users and the mail items can be delivered directly to the facility.

Mail items can include all types of mail, including packages and letters delivered by the US Postal Service, UPS, Fed Ex, and other letter/package delivery services. For example, a class and type can be associated with a mail item. A mail class is a category of mail defined by the mail's delivery service and content. For example, express mail, priority mail, first-class mail, parcel post, bound printed matter, media mail, standard mail and periodicals are the mail classes recognized by the U.S. Postal Service. Additionally, as discussed above, there are various commercial package, parcel, and/or letter delivery services, including courier services, which also can have discrete categories of mail (e.g., UPS land or UPS air). A mail type is a category of mail defined by the mail's dimensions. For example, postcard, letter, envelope, flat and parcel are the mail types recognized by the U.S. Postal Service.

Item Induction

Induction is the process of gathering data from or about individual items and/or sorting the items based on the gathered data. In certain embodiments discussed below in greater detail, the item management system includes a remote mail system and induction includes the process of gathering data about individual mail items and/or sorting the mail pieces based on the gathered data. There are several methods which can be used or combined to accomplish the induction process.

For example, the induction process can be accomplished manually where a person gathers data from the mail items and sorts them into containers, cartridges, or totes. For example, a person can read the outside of the envelope or parcel and sort the mail items into different containers. Manual induction requires no pre-sorting of received mail pieces into particular mail classes or mail types and manual induction successfully inducts all but the most badly damaged mail pieces. Additionally, manual induction does not require another induction method to handle exceptions. In selected embodiments where the mail item is going to be stored in an automated system, an identifying feature or identification tag, discussed above, can be applied to the mail item.

In other embodiments, an automated induction process can be used to gather data from a mail piece and sort it into a container, cartridge, or tote. An automated induction process can have various arrangements. For example, in certain embodiments a one-pass induction process can be used. In other embodiments a two-pass induction process can be used.

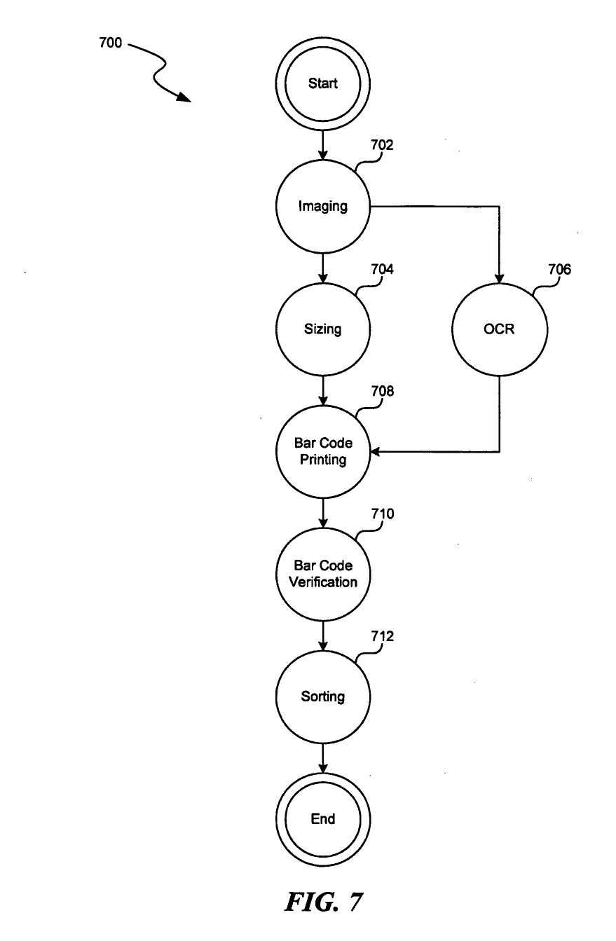

The one-pass induction process gathers data on a mail piece and sorts it in “one touch”. Once the person or machine has handled the mail piece, it need not be handled again to complete the induction process. FIG. 7 is a schematic flow chart showing a one-touch induction process 700 in accordance with certain embodiments of the invention. In the illustrated embodiment, the one-touch induction process 700 includes imaging 702, sizing 704, optical character recognition (OCR) 706, bar code printing 708, bar code verification 710, and sorting 712. The imaging process 702 includes capturing an electronic (e.g., digital) image of a mail item. In selected embodiments where an OCR process is going to be used as part of the induction process, it can be desirable to use a resolution of 240 dots per inch (DPI) or greater. The sizing process 704 can include measuring selected physical dimensions and/or characteristics of a mail piece. For example, for postcards and letters, sizing can include determining a length, height, and weight for the mail item. For flats and parcels, sizing can include determining a length, height, thickness, and weight of the mail item.

The OCR process 706 can be used to locate a portion of a mail item image that contains data relevant to the sorting process 712 and translates at least part of that portion of the image into text. The bar code printing process 708 places machine readable data onto the mail items. The bar code may or may not contain content extracted during OCR. In other embodiments, as discussed above, other identifiers, such as one or two dimensional symbols, radio frequency identification tags, identification tags, or other machine readable indicators can be used. The bar code verification process 710 reads the newly-printed machine-readable bar code (or other identification tag) on the mail item to confirm that bar code printing (or identification tagging) was successful. The sorting process 712 can divide the mail items into groups based on relevant data gathered from each mail item and/or prepare the mail items for storage. For example, in certain embodiments each piece of mail can be placed in an individual container for storage. In other embodiments, the mail can be grouped in larger containers and separated during the storage process. In still other embodiments, the induction process electronically sorts the mail items by their identification tags, but the mail items are not physically sorted until they enter the storage process.

In certain embodiments, the item management system can use commercially available machinery to perform various portions of the induction process. For example, in selected embodiments one of the Olympus Series Mail Sorting Machines, available from Pitney Bowes of Danbury, Conn., can be used to perform at least a portion of the imaging and sorting process discussed above. Additionally, in selected embodiments manual induction is still required to handle certain mail items. For example, a mail item that is too large to be inducted by machine can be inducted manually. Additionally, in certain embodiments the mail items may be manually inspected for damage and/or manually oriented before entering the automated portion of the induction process so that the induction equipment can gather relevant data from the mail items.

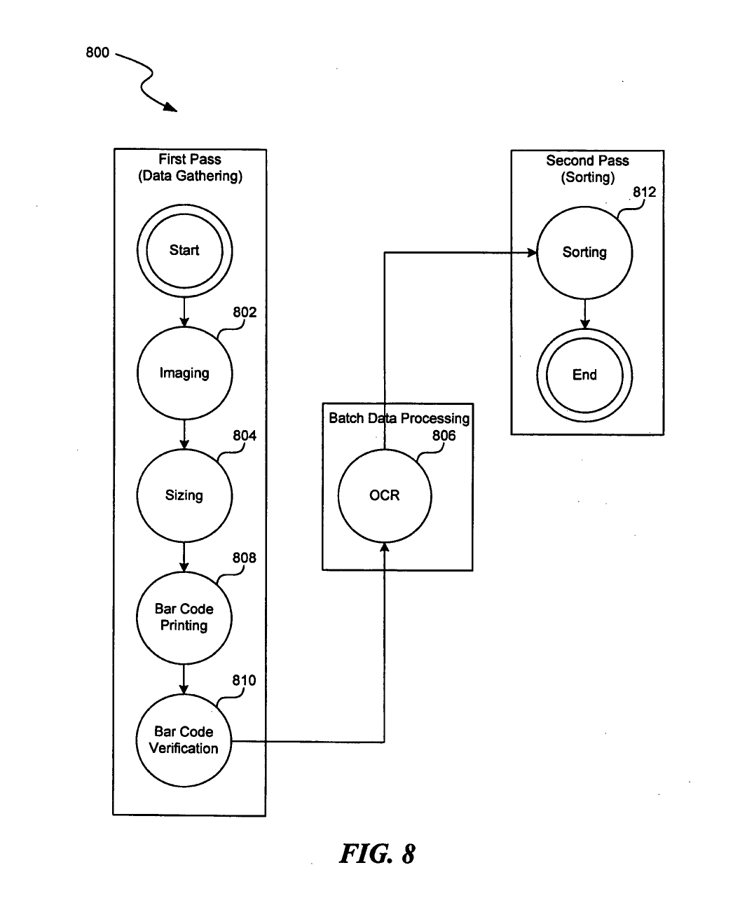

FIG. 8 is a schematic flow chart showing a two-touch induction process 800 in accordance with other embodiments of the invention. For example, in certain embodiments the “first pass” of a two-pass induction process gathers data from the mail item by performing an imaging process 802 and a sizing process 804, similar to the imaging and sizing processes discussed above with reference to FIG. 7. Additionally, a bar code printing process 808 includes printing and applying a bar code to the mail item so that the mail item has a unique identification. The bar code verification process 810 includes reading the bar code to verify that the bar code is readable and correct.

In the illustrated embodiment, a batch data process 806 includes an OCR process and/or other computational techniques to compute data associated with the mail item based on the imaging process 802 and the sizing process 804. The data is also associated with the unique identification or bar code. For example, in various embodiments the data can include:
The user or recipient of the mail item (e.g., via the delivery address determined via the OCR process);
The sender of the mail item;
The mail class of the piece (e.g., determined via the OCR process and an image of the postage area); and/or
An estimated page count of envelopes and flats (e.g., based on size and weight).

In the illustrated embodiment, the mail item passes quickly through the imaging 802, sizing 804, bar code printing 808, and bar code verification 810 processes providing. The mail item can then be held in a cache (if necessary) while the batch data process 806 is performed. Accordingly, the batch data process 806 can use as much time as required to extract and compute the sort data for each mail item. After the batch data process 806 is complete, the mail item can undergo the sorting process 812, similar to the sorting process discussed above with reference to FIG. 7. In certain embodiments, the two-pass induction process 800 can provide data that is more complete and accurate than that attained with the one-pass induction process, while maintaining a fairly high rate of throughput.

In other embodiments, the induction process can include multiple imagers and/or OCR algorithms, and mail items can be re-scanned and/or images can be re-evaluated when portions of the item are hard to identify. In other embodiments, the system may include hardware and/or software for processing the images such that the format or specific patterns of the image may be recognized for other uses. Such uses may include but are not limited to address blocks, iconography, graphics, text, and/or numeric/characters entered in blocks associated with various forms. In still other embodiments, the processing of an image for character recognition is further enhanced for speed and accuracy by using database information regarding the range of expected content can be accessed and used for comparison and/or verification purposes to determine the image content. For example, if certain mail items are received that have a specific marking that indicates the mail item is being sent to a person in a specific organization, identifying the user or recipient can be determined by searching a company specific database versus a database that contains all system users. In yet other embodiments the item management system includes multiple induction processes for different types/size mail items. Additionally, the system can include a method (automated and/or manual) for separating the different types/size mail items and sending them through the corresponding induction process. In selected embodiments at least a portion of the storage and retrieval process can be computer controlled.

Item Storage

Item storage is the process of storing items in a trackable manner so that they can be accurately and quickly identified, located, and/or retrieved at a later time. In certain embodiments, the storage process can include storing a non-uniform item in a uniform structure. For example, various embodiments are discussed below where the item management system includes a remote mail system and the storage process includes storing items so that they can be identified, located, and/or retrieved at a later time. There are several methods which can be used or combined to accomplish item storage.

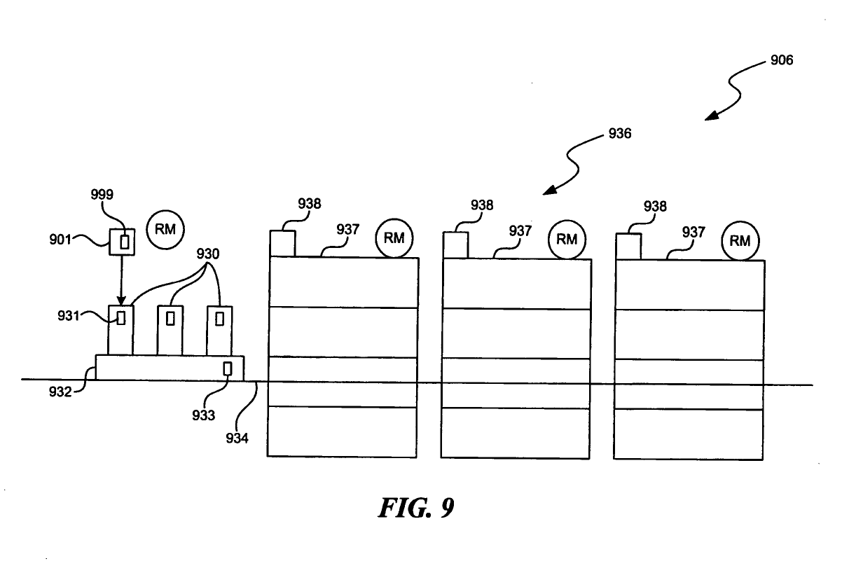

FIG. 9 is a partially schematic illustration of a storage center 906 in accordance with certain embodiments of the invention. In FIG. 9, after mail items have been inducted, each mail item 901 can be individually inserted into a container 930 (e.g., a rigid container) or cassette of sufficient size to contain the entire item 901 (e.g., the packaging and contents). In other words, each container 930 holds only one mail item 901. In certain embodiments, the mail item 901 can be placed into its designated container 930 via an automated process or handling equipment (e.g., via a robotic manipulator RM). In other embodiments, the mail items 901 can be placed into their respective containers 930 or cassettes during the induction process and then enter the storage process. Additional sorting can also be accomplished during the storage process. In selected embodiments, the containers 930 can be an injection molded sleeve with 5 sides and one open side or face for the insertion and removal of mail items 901. In certain embodiments, the container 930 can have an anti-static configuration. In various embodiments, the container 930 can also have internal ribs oriented toward the open face to prevent the portions of the mail item 901 from clinging to the inner surfaces of the container 930.

The containers 930 can each have a unique identifier 931 so that each container can be uniquely identified by visual and/or electronic means. For example, in certain embodiments the containers 930 can each carry an identification tag (e.g., barcodes or radio frequency identification tags) so the mail item in the container can be associated with that container. The containers 930 can also include physical features (e.g., engagement mechanisms) which allow them to be inserted into and retrieved from a storage rack system 936 (which includes one or more racks 937), be transported on a conveyor system 934, be carried by a carrier 932 (discussed below in further detail) and/or be manipulated by a robotic manipulator RM. Such features may include but are not limited to slots, pins, grooves, hooks, or other engagement devices for engaging portions of the rack system 936, conveyor system 934, and/or robotic manipulator RM.

In the illustrated embodiment, one or more of the containers 930 can be carried by a carrier 932 or pallet. In selected embodiments, the containers 930 can be uniform in shape and size so any container can be positioned in any location or slot on a carrier 932. In certain embodiments, the carriers 932 can allow multiple containers 930 to move through the storage center and/or be stored in the storage center together. The carrier 932 to also carry an identifier 933 so that movement of the carrier can be tracked throughout the storage center. In certain embodiments, the carriers 932 can include features to permit stacking or nesting them for storage (e.g., in the rack system 936). The carriers 932 can also include features that allow the container 932 to be inserted into and retrieved from a storage rack system 936, be transported on a conveyor system 934, and/or be manipulated by a robotic manipulator RM.

The carriers 930 can be dispatched along a conveyor system 934 to the storage rack system 936. The conveyor system 934 may include transfer locations to re-direct the carriers 932 to other sections of the storage center and/or out of the storage center (e.g., to the processing center). In certain embodiments, decisions regarding the direction or diversion of the carriers 932 can be partially or completely automated. Additionally, in selected embodiments at least a portion of the storage and retrieval process can be computer controlled. In various embodiments, the conveyor system can include return lines to allow carriers 932 that have been moved out of the storage center (e.g., moved to processing) to be directed back to the induction center and/or allow containers with mail items to return to the rack system 936. This can permit items to be retrieved in one portion of the rack system 936 and directed to a different portion of the rack system 936 or moved out of the storage center and returned.

In the illustrated embodiment, a carrier 932 with one or more containers 930 is transported via the conveyor system 934 to an individual rack 937 in the rack system 936, where the carrier 932 (with the containers 930) is removed from the conveyor system 934 and placed into the individual rack 937. The item 901 can carry a unique identifier 999. Accordingly, if the item identifier 999 was associated with the container identifier 931 and the container identifier 931 was associated with the carrier identifier 933, the item identifier 999 can now be associated with the individual rack in which the carrier 932 is stored. For example, the individual rack 937 can include a rack identifier 938, each location in the rack can include an identifier, and/or the system can identify the rack by the position in the conveyor system 934 where the carrier 932 was removed and placed in a rack. In one embodiment, all of the identifiers include bar codes and the bar codes are scanned at each step of the process. In other embodiments, the identifiers include radio frequency identification tags which are sensed at each step of the process.

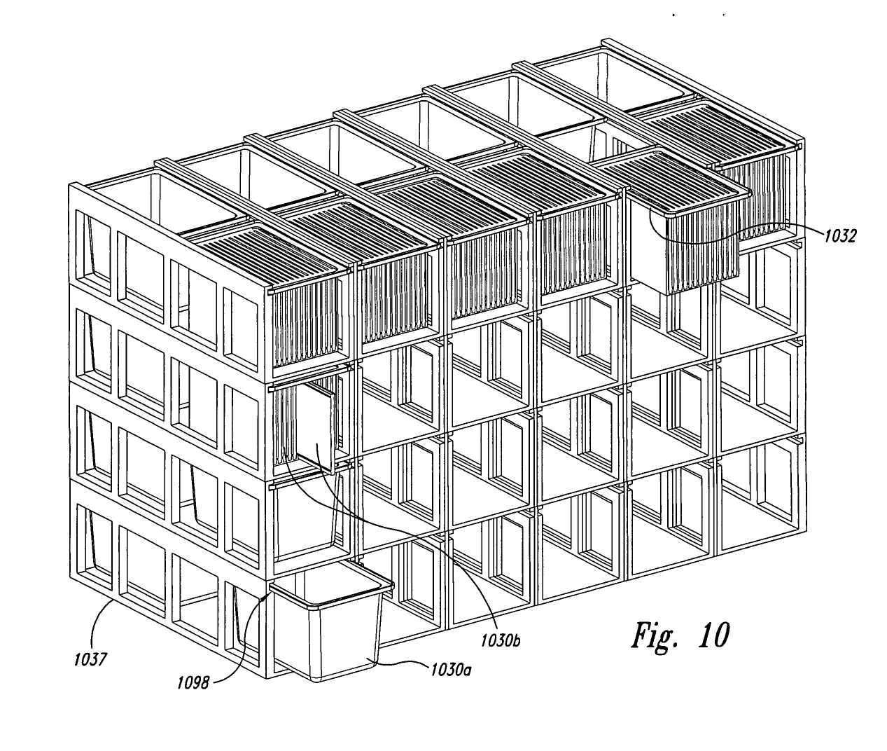

FIG. 10 is an isometric illustration of an individual storage rack 1037 configured to store multiple different types of containers in accordance with various embodiments of the invention. For example, the rack 1037 shown in FIG. 10 is configured to store a first container 1030a without a carrier. In certain embodiments, the first carrier 1030a is moved throughout the storage center without the use of a carrier. In other embodiments, the first carriers 1030a are moved throughout a least a portion of the storage center on a carrier and removed from the carrier when they are placed into the rack 1037. As discussed above, the rack 1037 and first container 1030a include engagement mechanisms 1098 to aid in interfacing and/or securing the first container 1030a to the rack 1037. As discussed above, similar engagement mechanisms can be used on other containers, other racks, robotic manipulators, portions of the conveyor system, and/or other storage center components. In the illustrated embodiment, the rack 1037 also carries second containers 1030b. The second containers 1030b are carried by carriers 1032, which in turn are carried by the rack 1037. In the illustrated embodiment, the individual second containers 1030b can be removed individually from the carriers 1032, even while the carrier is in the rack 1037. Additionally, the carriers, with any associated second containers, can be removed from the rack 1037 as a unit.

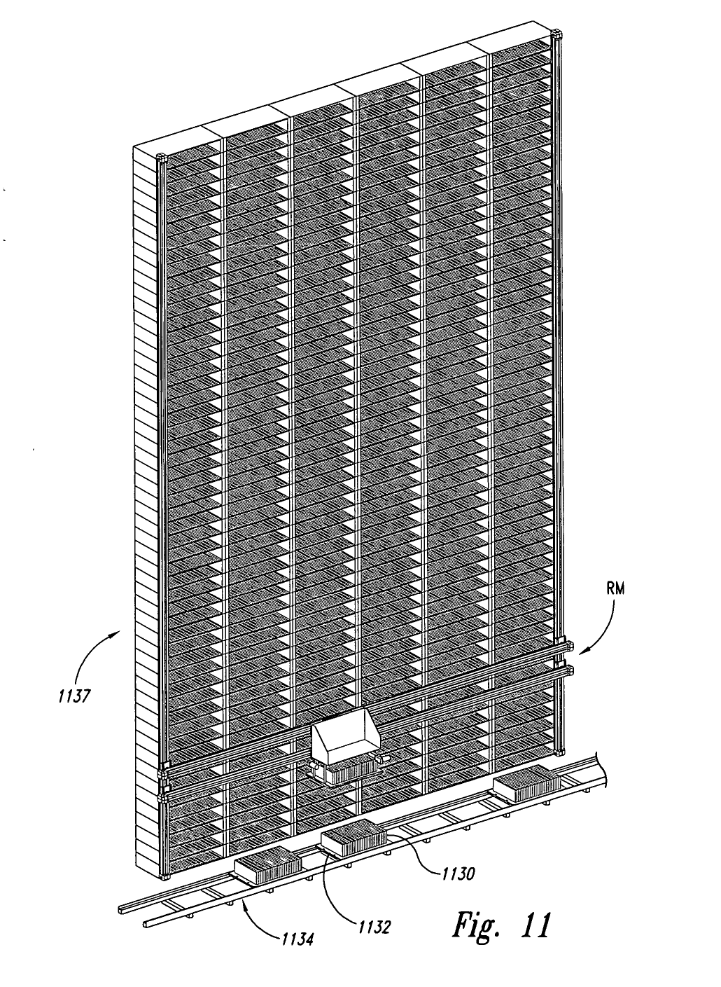

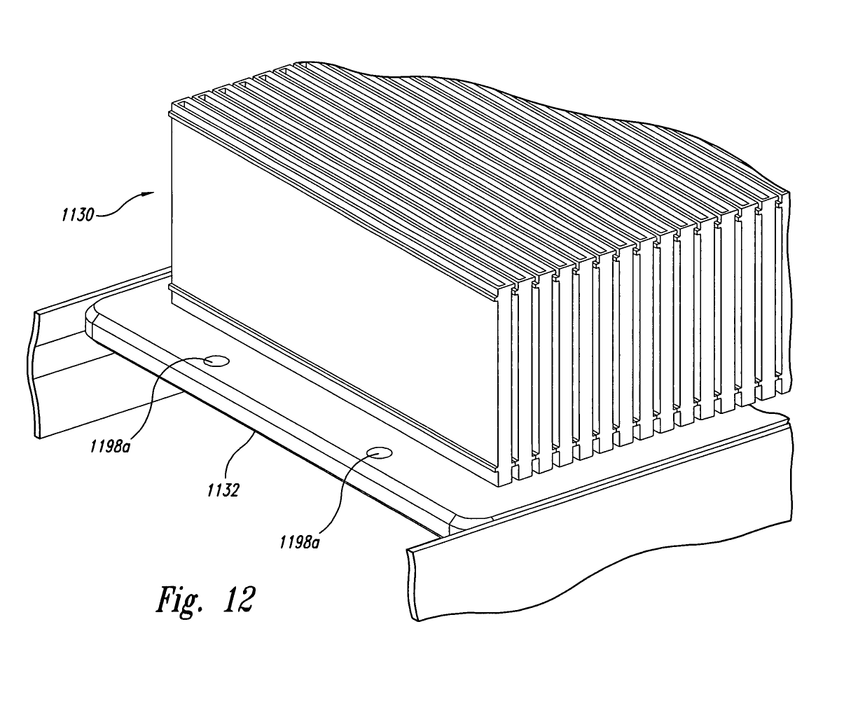

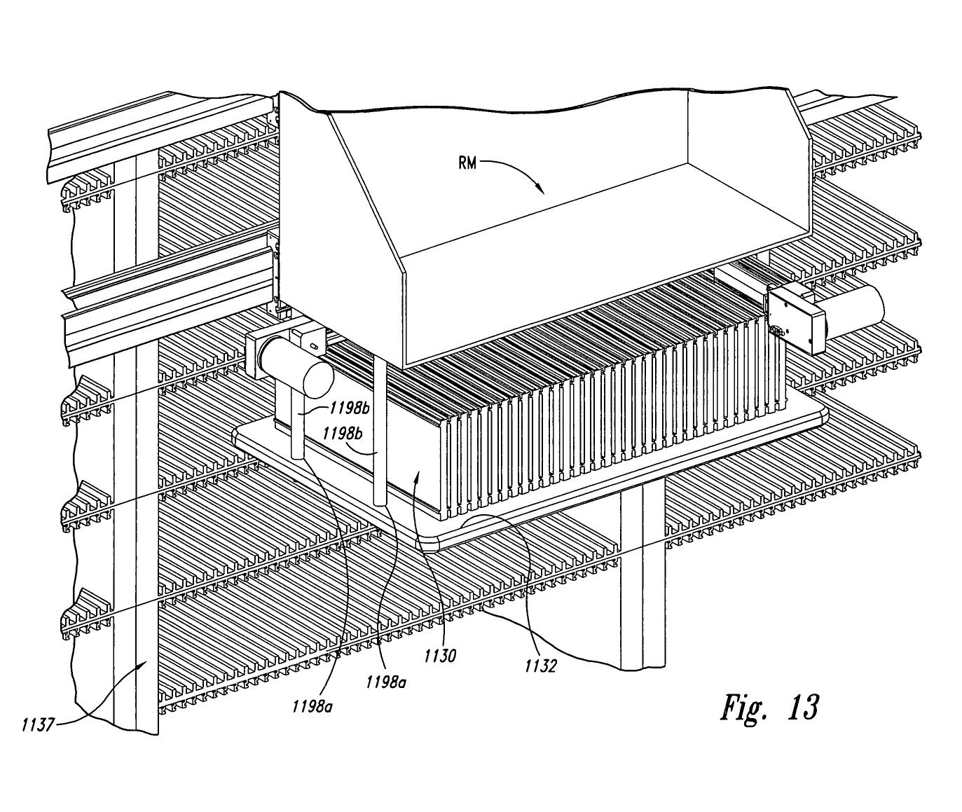

FIGS. 11-13 are isometric illustrations of a rack 1137 with a robotic manipulator RM that is used to insert containers 1130 into the rack 1137, remove containers 1130 from the rack, and manipulate containers 1130 relative to the rack 1137 in accordance with other embodiments of the invention. FIG. 11 shows the rack 1137, the robotic manipulator RM carrying a carrier 1132 with containers 1130, and a portion of a conveyor system 1134 carrying additional carriers 1132 and containers 1130. FIG. 12 shows a portion of a carrier 1132 carrying containers 1130. Two first engagement devices 1198a (e.g., female engaging devices) are shown in FIG. 12, however, other embodiments can have more, fewer, or no first engagement devices 1198a. FIG. 13 shows the robotic manipulator RM carrying a carrier 1132 with multiple containers 1130. In FIG. 13, the second engaging devices 1198b (e.g., male engaging devices) have engaged first engaging devices 1198a on the carrier 1132. The robotic manipulator RM is configured so that it can move at least vertically and horizontally with respect to the rack 1137 and the conveyor 1134 (shown in FIG. 11). Additionally, the robotic manipulator 1137 is configured so that it can move individual containers 1130 in and out of the rack 1137. In the illustrated embodiment, the rack 1137 includes multiple engaging devices for engaging the individual containers 1130 as they are slid into and removed from the rack 1137. Once one or more containers 1130 are removed from the carrier 1132 and placed in the rack 1137 or removed from the rack 1137 and placed on the carrier 1132, the carrier 1132 can be returned to the conveyor system 1134 (shown in FIG. 11) and moved throughout or out of the storage center.

In other embodiments, the storage center can have other arrangements. For example, in certain embodiments multiple mail items are placed in a single container based on user and/or operator defined rules. For example, multiple magazine type mail items for a specific user are placed in a single container. In still other embodiments, the containers can be integral with the carriers. In yet other embodiments, the mail items are placed in containers, moved throughout the storage center, and transferred to other containers for placement into a rack.

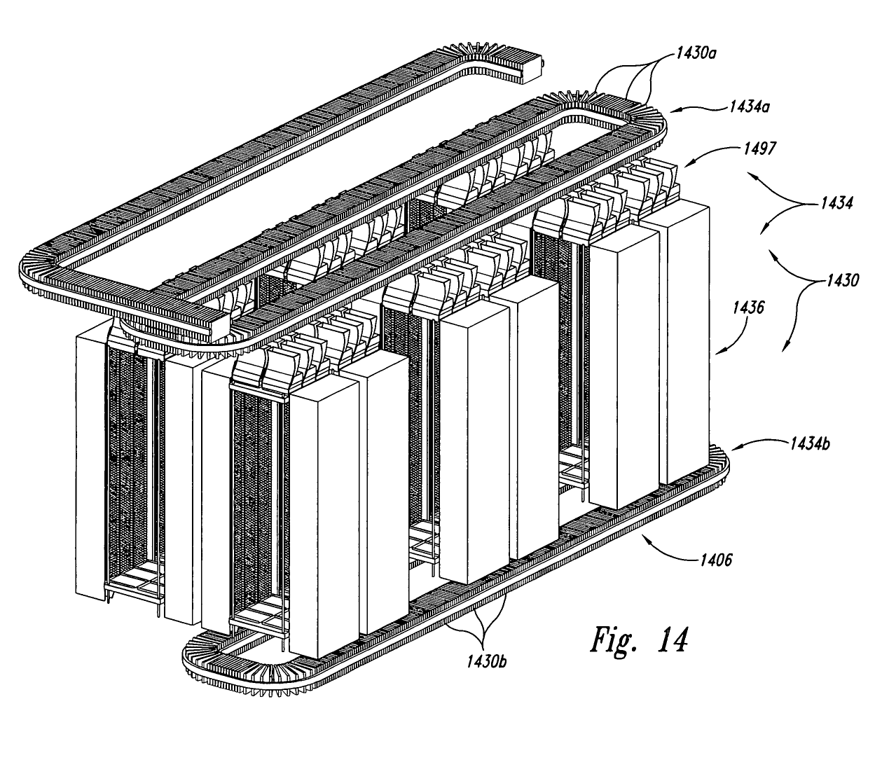

For example, FIG. 14 is an isometric illustration of a portion of a storage center 1406 with containers 1430 permanently attached to one or more conveyor systems 1434 in accordance with certain embodiments of the invention. In the illustrated embodiment, the storage center 1406 includes a first conveyor 1434a that has first containers 1430 permanently attached to the first conveyor 1434a. In the illustrated embodiment, each first container 1430a has an open top, four sides, and a sliding or moving bottom which can be opened, actuated, or retracted to allow the material to drop out the bottom when desired. Mail items are placed in the containers during the induction process or the storage process.

In FIG. 14, when a mail item is above the rack destined for storing it, the bottom of the container opens and the mail item drops into either a cache or directly onto a robotic manipulator. In the illustrated embodiment, the mail item drops through a chute system 1497, which guides the mail item between the first container 1430a and the specified rack. In other embodiments, the storage center 1406 does not include a chute system 1497. If the mail item falls into a cache, it is held in the cache until the robotic manipulator is available to handle the mail item. The robotic manipulator can move relative to the corresponding rack and move the mail item into and out of storage locations in the corresponding rack. To remove material from the rack, the robotic manipulator removes the mail item from its storage slot and places or drops the mail item to a location where the mail item can be dropped or placed in a second container 1430b on the second conveyor 1434b and moved away from the storage rack.

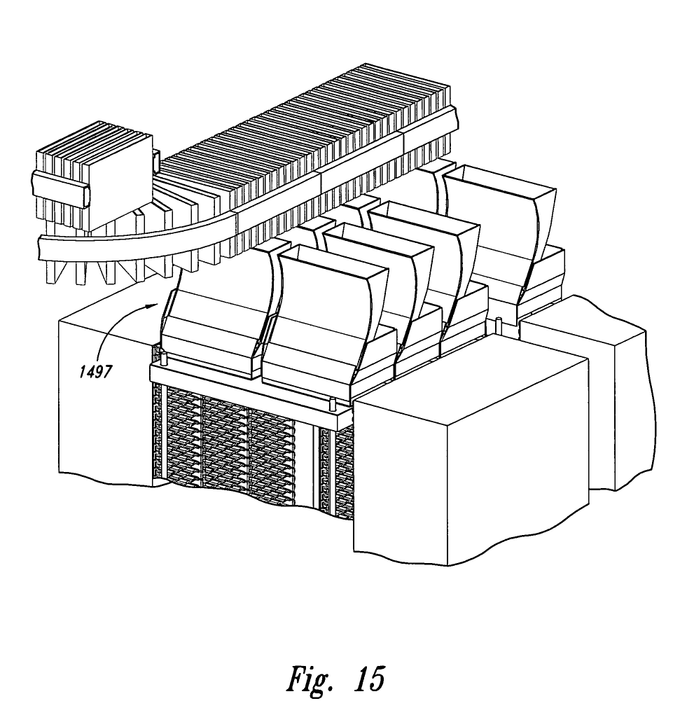

FIG. 15 is an isometric illustration of a chute system used to transfer items between first conveyor 1434a and the rack system 1436 shown in FIG. 14. In other embodiments, the storage center can include additional conveyors, each having permanently attached containers for moving mail items throughout the storage center. In some circumstances it can be necessary to transfer mail items between conveyor systems. In some of these embodiments, a chute system, similar to that shown in FIG. 15 can be used to aid the gravity transfer of mail items between one conveyor and another. In other embodiments, the transfers can be made without a chute system and/or with the aid of a robotic manipulator.

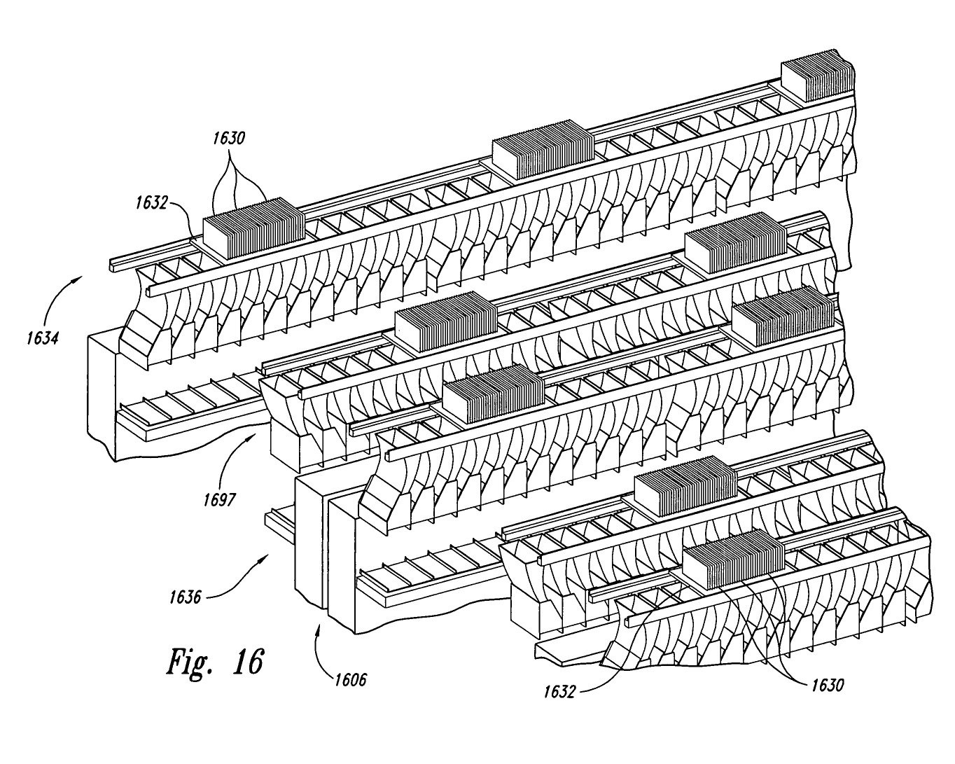

FIG. 16 is an isometric illustration of a portion of a storage center 1606 with a chute system 1697 for transferring containers 1630 between one portion of the storage center 1606 and another. For example, in FIG. 16 containers 1630 can be carried by carriers 1632 on a conveyor 1634. When a container 1630 is over a rack in the rack system 1636 designated to store the container 1630, the carrier 1632 can release the container 1630, allowing it to drop into a cache or onto a robotic manipulator. The container 1630 can then be stored in a manner similar to that for storing the mail item discussed with reference to FIG. 14. The chute system 1967 can aid in guiding the container into the rack. The container can be removed from the rack in a manner similar to that of removing the mail item discussed with reference to FIG. 14. In other embodiments, the storage center 1606 does not include a chute system 1697.

In certain embodiments, once materials are deposited in the rack system, a robotic manipulator may be used to sort, reorder, or otherwise organize the positions of a rack's contents for purposes of a sequenced retrieval order, grouping of items based on attributes, or to minimize the robotic traversal times for future retrievals. For example, during periods when a robotic manipulator of a given rack is not engaged in placing items from a conveyor system into storage or retrieving items and placing them on the conveyor system, the robotic manipulator can be directed to retrieve and re-insert containers to better organize the contents of the rack. This may be accomplished by moving groups of containers (e.g., a group of containers stored on a carrier) or by moving individual carriers. In certain embodiments, the storage system can reorganize containers by moving containers between racks, for example, by using a portion of a conveyor system.

In one embodiment, mail items are re-ordered in the rack so that the mail items are retrieved from the rack system in the order or in the reverse order of a carrier delivery route. This can involve a computer system determining the carrier route order and selecting all the corresponding mail items in the storage center that match the chosen sequence. The mail may be retrieved in order regardless of whether it is distributed throughout the storage center or entirely contained within a single rack. The same logic can be used for initial placement of mail items in the storage center. For example, in some embodiments items can move from induction to specific racks associated with certain sequences or rules and/or be stored within certain portions of a rack based on these selected sequences or rules. In other embodiments, items can be stored on racks that are proximate to one another to enhance retrieval sequencing.

Item Retrieval

As discussed above, items can be retrieved by the storage center and sent to the processing center for processing. In certain embodiments, the storage center can retrieve items in a specific sequence or order regardless of where they are stored in the storage center (e.g., stored in the rack system). For example, in selected embodiments this can be done by transporting a carrier to various locations throughout a rack system to collect various mail items and/or containers in a specific sequence or grouping. In other embodiments, multiple carriers can be directed through the system to collect items for segments of a sequence, and when all items are collected, the carriers can exit the system in the order necessary for further processing. In still other embodiments, multiple carriers can be directed through the system to collect items for a selected grouping and once all the items are collected, the carriers can exit the system to carry the items to the processing center.

Item Processing

Items retrieved from the storage center can be processed in a variety of ways depending on the type of items being stored, the action(s) desired by a user, and/or the action(s) desired by an operator. For example, processing can include, but is not limited to, removing items from the item management process, shipping items (e.g., to a user or other entity), performing various manual operations on items, altering the items, scanning or imaging the items, marking the items, separating the items, disposing of the items, recycling the items, destroying the items, and/or simply passing the items through the processing center and returning the items to the storage center (e.g., when an item has been removed with a group of other items from storage and/or an item has been removed from storage by mistake). In other embodiments, items that are being archived can be retrieved, moved through the processing center, and returned to the storage center for storage in a different area. In other embodiments, items can be archived (e.g., moved to another location in the storage center) without leaving the storage center.

In one embodiment, the item management system includes a remote mail system and items can be removed from storage so that at least a portion of the item can be scanned (e.g., the entire mail item including the packaging and contents). For example, as discussed above, a user can remotely review details about an item that has been inducted and stored, and provide instructions to have the document scanned. In response to the user's input, the document can be retrieved from storage and moved to the processing center for scanning. The scanning process can be fully automated, partially automated, or accomplished manually.

Once the mail item is received at the processing center, the scanning process can include scanning at least a portion of the packaging 1702 (e.g., the outside of the mail item) and making duplicate packaging materials 1704. For example, in certain embodiments a portion of an envelope that includes a bar code applied during the induction process can be scanned. A duplicate envelope can be printed with the same images and bar code. In other embodiments, the corresponding bar code can be electronically added to an image taken during the induction process and the composite image can be printed on the duplicate envelope. In other embodiments where other types of identification tags are used, a duplicate identification tag can be applied to the duplicate packaging materials.

The packaging can be opened (process portion 1706), either manually or using an automated extraction machine. For example, in certain embodiments an automated extraction machine can slit an envelope and remove the contents. In selected embodiments, the packaging can be scanned (process portion 1702) and the duplicate packaging material (process portion 1704) can be accomplished after the packaging has been opened or after the contents have been removed.

Once the packaging is opened and the contents removed, other portions of the mail item can be prepared for scanning (process portion 1708). For example, in certain embodiments, if the contents include multiple pages that are stapled and folded, the papers can be unfolded and the staples can be removed. The papers can then be placed between the original and duplicate packaging materials so that the scanner will be able to determine the start of the mail item and the end of the mail item. For example, the scanner or related computing device can determine that the entire mail item has been scanned when a repeat image or identification tag is sensed. The mail item can then be scanned in its entirety (process portion 1710). After scanning, the mail item (e.g., the contents and original packaging) can be placed in the duplicate packaging material (process portion 1712) and be returned to storage or undergo further processing. The scanned image of the entire mail item can then be sent to the user electronically for review. In certain embodiments, the scanned image can be manipulated (e.g., indexed and/or enhanced) before being sent to the user.

Document Storage, Item Storage, and Other Features

Although various embodiments of an item management system or process have been described above in the context of a remote mail system, in other embodiments the item management system or process can have other features and/or applications.

For example, in certain embodiments the item management system can include a document management system. For example, the item management system can receive an item (e.g., from a user via mail or delivery) that includes a pouch or other container (e.g., packaging) with one or more documents inside (e.g., content). In selected embodiments, the item can include bar code or other identifier when the item is received (e.g., the pouch can already have an identifier when the user places the documents in the pouch) and the item can be inducted into the system using this identifier and stored. Additionally, in certain embodiments the user can provide a description of the pouch content and/or other information about the pouch via the user interface so that this information can be stored and associated with the identifier when or after the item is inducted. This information can also be stored in a searchable database or system that allows the user to use the system to find items stored via the bar code with the associated information.

The item can be stored per a set of rules pre-established by the user and/or the operator. In certain embodiments, the container portion of the item can be sealed and the item can remained sealed until it is retrieved and returned to the user, protecting the privacy of the containers contents. Additionally, the seal can provide an indication of whether the privacy and/or security of the item have been breached. A monitoring system, similar to those discussed above, can provide additional security.

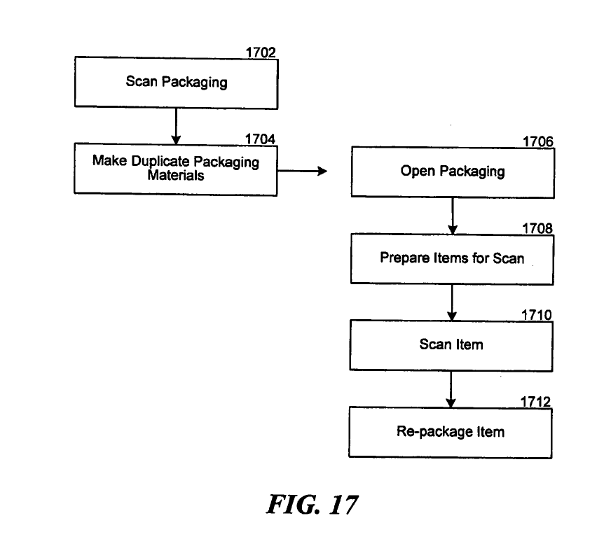

In other embodiments, the item can be processed before storage. For example, after induction the item can be moved to a processing center where the item can be opened, the contents scanned, and the item resealed (e.g., in a duplicate envelope as discussed above with reference to FIG. 17). The item can then be stored and the scanned images can be stored electronically to provide a record of what is being stored, to provide backup copies of the stored item, and/or to make the electronic images available for remote viewing.

In further embodiments, the item can be retrieved from storage and sent to a user via the processing center. The user can modify the item, for example, add and remove papers from a pouch, and return the item to the item management system. During the induction process, the item management system can identify the item as a returned item (e.g., based on an identification tag) and send the item to processing based on a pre-determined set of instructions. At processing the item can be opened and the contents can be scanned. The item can then be sent to storage. The new images can be compared to the stored record to determine changes made to the item and/or to create a new record of what is being stored. Accordingly, a user can have a current inventory of the item stored and/or a history of changes made to the item. Additionally, in other embodiments the processing center can provide other types of processing, for example, other types of processing can include recycling, shredding, copying, and shipping the item or a copy of the item to another entity. In still other embodiments, an item management system can include both a remote mail system and a document management system.

The embodiments of the item management system discussed above can also be used for other types if items. For example, in certain embodiments an item management system can be used to store items that include CD/DVD. The CD/DVD can be configured for any type of data storage, including audio and/or visual data. The system can be used to track the location of the CD/DVD, how often they have been used, how they have been used, and/or how they have been modified. Accordingly, this feature can be particularly useful for an in-store or by-mail CD/DVD rental facility. In other embodiments, the items can include books that are lent to various entities (e.g., by a library), provide many of the same features and advantages discussed with reference to CD/DVDs.

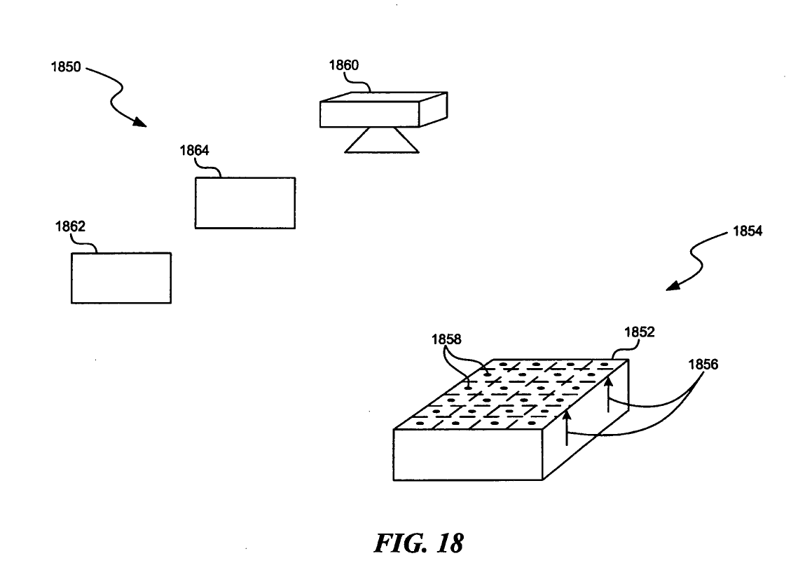

Additionally, it will be understood by those skilled in the art that various embodiments of item management systems can be used on a small scale (e.g., in an individual company's mail room) or on a large scale (e.g., a remote mail and document management system serving multiple companies around the world). For example, FIG. 18 illustrates a manual induction station 1850 that might be used in a corporate mail room in accordance with certain embodiments of the invention. A similar process can be used in conjunction with an automated induction system (e.g., for use with a large scale remote mail system) to induct items that are incompatible with the automated induction process (e.g., to induct items that are too large for the automated system).

In the illustrated embodiment, the manual induction station 1850 includes a table or platform 1852. Various sensors can be coupled to the platform. For example, in FIG. 18 weight sensors 1856 are positioned so that a weight of an item placed (e.g., manually placed) on the platform 1852 can be sensed. Additionally, in the illustrated embodiments electromagnetic sensors 1858 (e.g., photo diodes) are positioned on or in the platform 1852 to sense the size (e.g., a two dimensional size) and/or shape of an item based on the number of electromagnetic sensors 1858 that are covered when the item is placed on the platform 1852.

Additionally, in the illustrated embodiment the manual induction station can include one or more imaging devices 1860 (e.g., a scanner and/or camera). The imaging devices 1860 can be handheld or mounted proximate to the platform 1852. The imaging device 1860 can be used to capture an image of all or a portion of an item, and in some cases can gather other information about the item. For example, in selected embodiments the platform 1852 can have dimensional markings 1854 on or in a surface of the platform 1852, and the imaging device 1860 can provide dimensional data by imaging the item relative to the dimensional markings 1854. The image device can be configured to compute various dimensions (e.g., width and length) of the item based on the image or send the image to a computer system, which in turn can compute the dimensions. In some embodiments, an index marking (e.g., a corner of the platform 1852) can be used to aid an operator in orienting the item on the platform 1852 to facilitate gathering dimensional data. In other embodiments, the platform 1852 can be transparent and the imaging device 1860 can be placed below or be integral with the platform 1852.

In still other embodiments, the manual induction system 1850 can have other arrangements. For example, in certain embodiments a data entry device 1862 can allow the operator to manually enter data regarding the item. For example, in selected embodiments the operator gathers dimensional data visually using the dimensional markings 1854 and enters the data into the data entry device 1862. In other embodiments, the operator uses the data entry device 1862 to enter any damage on the item that the operator observes. In still other embodiments, the manual induction station can include other device(s) 1864. For example, in one embodiment the other device(s) 1864 can include a device that provides an identifier for the item (e.g., a printer that prints a bar code sticker which the operator places on the item). In another embodiment, the other device(s) 1864 can include a device that reads identifiers, such as a bar code reader or radio frequency identification reader. In still other embodiments, the other device(s) 1864 can include a device that provides the operator with sorting instructions, for example, a computer monitor that provides instructions to the operator to place the item in a container and send it to storage or to send the item to processing based on a pre-determined set of rules as discussed above.

A feature of some of the embodiments discussed above is that an item management system can efficiently store non-uniform items in a uniform structure, track the location of the items, and retrieve the items when needed. An advantage of this feature is that the system can save time and money when storing and managing items that have diverse physical characteristics. Another advantage of some of the embodiments discussed above is that physical items can be managed remotely by a user. For example, items can be physically received, stored, tracked, and/or processed at a location remote from the user and the user can electronically review and manage the items via a network. An advantage of this feature is that it provides consistent access to important information regardless of the location and/or schedule of the user. Additionally, when an item management system includes a remote mail system, this feature can provide users with a single address that never changes. Another feature of some of the embodiments described above is that various items can be received and stored in a secure environment. This can be especially useful for document management systems and remote mail systems.

From the foregoing, it will be appreciated that specific embodiments of the invention have been described herein for purposes of illustration, but that various modifications may be made without deviating from the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/We claim:

1. A method of managing physical items for remote entities, comprising:
receiving a physical item in a location remote from the entities, the item being associated with at least one of the remote entities;
determining which of the remote entities is associated with the item;
imaging at least a portion of the item;
collecting data about the item;
providing at least a portion of the data to at least one of the associated entities via a computer network;
providing a unique identifier with the item;
storing the item in a discrete storage location; and
associating the discrete storage location with the identifier of the physical item.

2. The method of claim 1, further comprising:
retrieving the item from storage location; and
processing the item.

3. The method of claim 1, further comprising processing the item in accordance with instructions from the at least one of the associated remote entities.

4. The method of claim 1, further comprising monitoring at least one of receiving a physical item, collecting data about the item, and storing the item.

5. The method of claim 1 wherein monitoring includes collecting visual images of the item during at least one of receiving a physical item, collecting data about the item, and storing the item.

6. The method of claim 1, further comprising:
receiving processing instructions via a computer network from the at least one associated entities;
retrieving the item from storage location;
processing the item in accordance with the processing instructions.

7. The method of claim 1 wherein collecting data about the item includes at least one of weighing the item, dimensioning the item, and scanning the item.

8. The method of claim 1, further comprising sending information about the item to the at least one of the associated remote entity from where the item is located, the information including at least one of an image of a portion of the item, information about a physical characteristic of the item, the date the item was received, and information about the status of the item.

9. The method of claim 1, further comprising:
retrieving the item from the storage location; and
processing the item, wherein processing the item includes at least one of sending the item to the at least one of the associated entities, sending the item to an entity other than the at least one of the associated entities, recycling the item, destroying the item, shredding the item, scanning the item, and returning the item to storage.

10. The method of claim 1 wherein processing the item includes imaging the item or contents of the item to collect image data, and providing the image data to the at least one of the associated entities via a computer network.

11. The method of claim 1 wherein the physical items are mail items, the physical item is a piece of mail, and the at least one of the associated entities is an intended recipient of the piece of mail.

12. The method of claim 1 wherein the physical items are non-homogeneous in shape and size, and further comprising placing the item in one of a plurality of carriers having a substantially homogeneous shape and size, and moving the item and carrier together as a unit to the storage location.

13. A method of managing documents for remote entities, comprising:
receiving a physical document in a location remote from the entities, the document being associated with at least one of the remote entities;
determining which of the remote entities is associated with the document;
collecting data about the document;
providing at least a portion of the data to at least one of the associated entities via a computer network;
providing a unique identifier with the document;
storing the document in a discrete storage location; and
associating the discrete storage location with the identifier of the physical document.

14. The method of claim 13 wherein the document includes a packaging material and content inside the packaging material, and wherein the method further comprises:
retrieving the document from storage; and
processing the document, wherein processing the document includes:
making a duplicate of the packaging material;
opening the packaging material and removing the content;
scanning the content; and
re-packaging the content in the duplicate packaging.

15. The method of claim 13 wherein the document includes a packaging material and content inside the packaging material, and wherein the method further comprises:
retrieving the document from storage; processing the document, wherein processing the document includes:
making a duplicate of the packaging material;
opening the packaging material and removing the content;
scanning the content; and
electronically sending images of the content to a user.

16. The method of claim 13 wherein the document includes a packaging material and content inside the packaging material, and wherein receiving a document includes receiving a document a first time, determining which of the remote entities is associated with the document includes determining which of the remote entities is associated with the document a first time, storing the document includes storing the document a first time, and associating the discrete storage location with the identifier includes associating the discrete storage location with the identifier a first time, and wherein the method further comprises:
scanning the content of the document prior to storing the document the first time;
retrieving the document from storage;
sending the document to at least one of the associate entities;
receiving the document a second time;
determining which of the remote entities is associated with the document a second time;
scanning the content of the document prior to storing the document a second time; and
comparing the images from scanning the content of the document prior to storing the document the first time to the images from scanning the content of the document prior to storing the document a second time to determine how the document has changed.

17. The method of claim 13 wherein the document includes a packaging material and content inside the packaging material, and wherein the method further comprises scanning the content of the document prior to storing the document to provide (a) a backup copy of the stored document, (b) images to a user of the stored documents, or (c) both (a) and (b).

18. A method of storing items having non-uniform sizes and shapes in a uniform structure, comprising:
receiving a first physical item having a fist exterior size and a first exterior shape;
providing a first unique identifier for the first item;
receiving a second physical item having a second exterior size different than the first exterior size and a second exterior shape different than the first exterior shape;
providing a second unique identifier for the second item;
placing the first item in a first container having a third exterior size and a third exterior shape;
placing the second item in a second container having the third exterior size and the third exterior shape;
storing the first item in a rack system at a first location having a third unique identifier;
associating the first identifier with the third identifier;
storing the second item in rack system at a second location having a fourth unique identifier;
associating the second identifier with the fourth identifier;
moving the first item from the first location to a third location in the rack system to improve efficiency when retrieving the first and second items from the rack system in a selected sequence, the third location having a fifth unique identifier; and
associating the first identifier with the fifth identifier.

19. The method of claim 18 wherein storing the first item includes storing the first item in the first container.

20. The method of claim 18 wherein storing the first item includes removing the first item from the first container and storing the first item in the first location.

21. A method of managing physical items for remote entities, comprising:
receiving a physical mail item in a location remote from the entities, the mail item being associated with at least one of the remote entities;
determining which of the remote entities is associated with the mail item;
collecting data about the mail item;
providing at least a portion of the data to at least one of the associated entities via a computer network;
providing a unique identifier with the mail item;
storing the mail item in a discrete storage location; and
associating the discrete storage location with the identifier of the physical mail item.

22. A method of managing physical items for remote entities, comprising:
receiving a physical item in a location remote from the entities, the item being associated with at least one of the remote entities, the item having an identifier;
determining which of the remote entities is associated with the item based on the identifier;
storing the item in a discrete storage location; and
associating the discrete storage location with the identifier of the physical item.
